(19) United States
(12) Patent Application Publication
(10) Pub. No.: US 2016/0072545 A1
(43) Pub. Date: Mar. 10, 2016

(54) METHOD AND/OR SYSTEM FOR ESTIMATING A FREQUENCY OF A RECEIVED SIGNAL

(71) Applicant: QUALCOMM Incorporated, San Diego, CA (US)

(72) Inventors: Alok K. Gupta, Encinitas, CA (US); Siavash Ekbatani, San Diego, CA (US)

(21) Appl. No.: 14/479,220

(22) Filed: Sep. 5, 2014

(51) Int. Cl. H04B 1/69; H04W 72/04; H04B 17/27; H04W 24/08

(52) U.S. Cl. CPC H04B 1/69; H04W 24/08; H04W 72/0453; H04B 17/27

(57) ABSTRACT

Described are a system and method for correcting a receiver frequency at a receiver to enhance detection of arrival of a wirelessly transmitted message. In particular, a frequency offset between receiver frequency and a carrier frequency may be estimated based, at least in part, on an autocorrelation of a bit sequence in a received message.

### BACKGROUND

1. Field

Subject matter disclosed herein relates to processing signals for use in positioning operations.

2. Information

Movement of objects transmitting a recognizable signal may be tracked by obtaining measurements of the transmitted signal at receivers maintained at known locations. In an implementation, a small tag comprising a transmitter may be fixed to a moving object to permit tracking the movement or location of the object over an area. For example, the small tag may broadcast a probe signal that includes a timing reference to enable an accurate determination of times of arrival at receivers.

### BRIEF DESCRIPTION OF THE FIGURES

Non-limiting and non-exhaustive examples will be described with reference to the following figures, wherein like reference numerals refer to like parts throughout the various figures.

FIG. 1 shows a moving receiver according to an embodiment.

FIG. 2 is a schematic diagram of a transmitter and a receiver according to an embodiment.

FIG. 3 shows fields for a frame or message to be transmitted in a wireless medium according to an embodiment.

FIG. 4. is a schematic diagram of aspects of a transmission device according to an embodiment.

FIG. 5 is a table showing a mapping between data symbols and chip values according to an embodiment.

FIG. 6 shows an allocation of chip values over in-phase and quadrature signal components according to an embodiment.

FIG. 7 illustrates pulse shaping applied to inphase and quadrature components according to an embodiment.

FIG. 8 is a schematic diagram of a receiver according to an embodiment.

FIG. 9 is a flow diagram of a process to update a receiver frequency according to an embodiment.

FIG. 10 is a schematic diagram of a correlator for use in a receiver according to an embodiment.

FIG. 11 is a flow diagram of a process for updating a receiver frequency according to an embodiment.

FIG. 12 is a plot of a signal-to-noise ratio (SNR) with a Cramer-Rao lower bound according to an embodiment.

### SUMMARY

Briefly, particular implementations are directed to a method of determining a frequency offset between a carrier frequency and a receiver frequency on a device for coherent integration of an ultra-wideband (UWB) probe signal, comprising: receiving, at a receiver operating at the receiver frequency, a modulated UWB probe signal, comprising a message containing a known sequence of bits, said modulated wireless signals comprising the carrier frequency; demodulating the modulated UWB probe signal using the known sequence of bits; determining a corrected receiver frequency by iteratively computing a frequency offset between the corrected receiver frequency and the carrier frequency based on an autocorrelation of said demodulated signal; updating the receiver frequency based, at least in part, on the corrected receiver frequency.

Another particular implementation is directed to a device for coherent integration of an ultra-wideband (UWB) probe signal comprising: a radio frequency (RF) receiver to downconvert a modulated UWB probe signal comprising a carrier frequency according to a receiver frequency, the modulated UWB probe signal comprising a message containing a known sequence of bits; and a baseband processor to: demodulate the modulated UWB probe signal using the known sequence of bits; determine a corrected receiver frequency by iteratively computing a frequency offset between the corrected receiver frequency and the carrier frequency based on an autocorrelation of said demodulated signal; and update the receiver frequency based, at least in part, on the corrected receiver frequency.

A device for coherent integration of an ultra-wideband (UWB) probe signal comprising: means for receiving, at a receiver operating at the receiver frequency, a modulated UWB probe signal, comprising a message containing a known sequence of bits, said modulated UWB probe signal comprising a carrier frequency; means for demodulating the modulated UWB probe signal using the known sequence of bits; means for determining a corrected receiver frequency by iteratively computing a frequency offset between the corrected receiver frequency based on an autocorrelation of said demodulated signal; and means for updating the receiver frequency based, at least in part, on the corrected receiver frequency.

It should be understood that the aforementioned implementations are merely example implementations, and that claimed subject matter is not necessarily limited to any particular aspect of these example implementations.

### DETAILED DESCRIPTION

As pointed out above, a low power tag placed on an object to be tracked may transmit a detectable probe signal that enables positioning and/or tracking movement of the object in an area or venue. In one particular implementation, receivers positioned at fixed locations may acquire a low power signal transmitted by a tag to, for example, detect times of arrival of the low power signal at the receivers. If the receivers are synchronized to a common clock, differences in times of arrival of the signal at the receivers may be used to compute an estimated location of the object. In one example implementation, a tag may transmit a low power ultra wideband (UWB) probe signal that is detectable by receivers positioned at known locations. To accurately detect a time of arrival of a UWB probe signal, a receiver may coherently integrate the received probe signal to detect the timing of a preamble comprising a known sequence of chips or symbols.

A UWB probe signal may be transmitted at a particular radio frequency (RF) carrier frequency. To downconvert a received probe signal, a receiver may comprise a complex mixer to mix the received probe signal with a sinusoid oscillating at a frequency that approximates the particular RF carrier frequency. The RF carrier frequency and the frequency of the sinusoid mixed with the received probe signal, however, may differ by an unknown frequency offset. According to an embodiment, precise estimate of this frequency offset, may be used to enhance performance of a coherent integrator used for detecting timing of a known bit sequence embedded in a received probe signal.

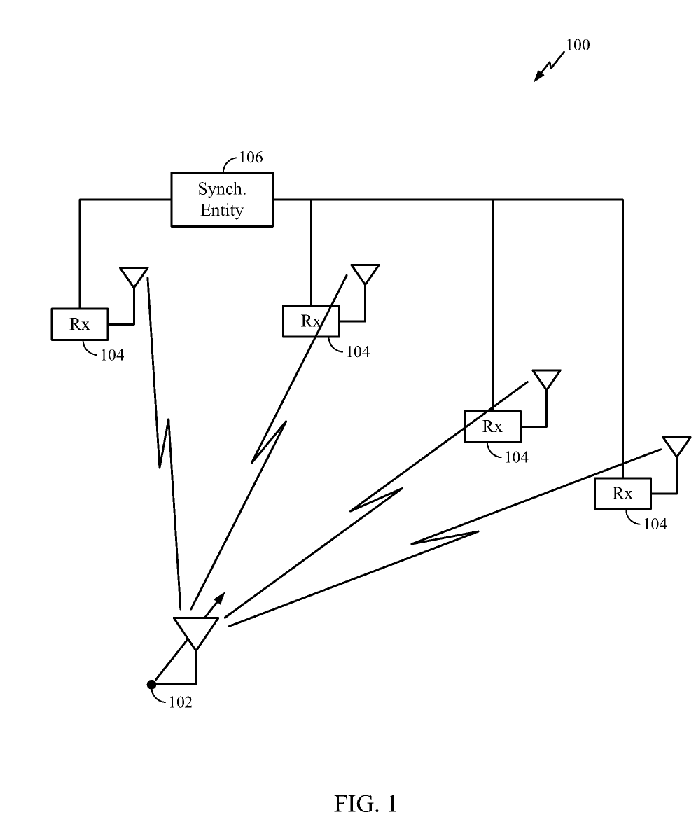

FIG. 1 shows a moving transmitter and receivers according to an embodiment. Receivers 104 may be positioned in venue 100 at known locations. Receivers 104 may also maintain clocks that are synchronized by a synchronizing entity 106. Having synchronized clocks may enable receivers 104 to accurately measure times of arrival of received signals according to a common time reference. Object 102 may comprise a tag that broadcasts a probe signal formatted, for example, at least in part according to one or more present or future versions of IEEE std. 802.15. In a particular implementation, and as discussed below, the broadcasted probe signal may contain a known bit sequence of 100 bits or longer that enables precise estimation of a frequency offset between a carrier frequency of the broadcasted probe signal and a receiver frequency.

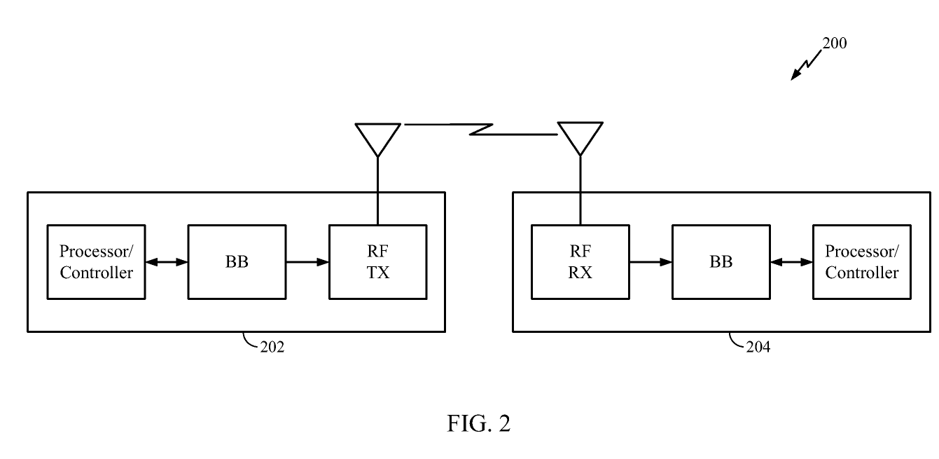

FIG. 2 is a schematic diagram of a transmitter and a receiver according to an embodiment 200. Transmitter 202 may transmit an encoded signal to receiver 204. Transmitter 202 may comprise a processor/controller to initiate transmission of frames or messages to be encoded at a baseband processor (BB) and upconverted to a radio frequency (RF) at an RF transmitter for transmission over a wireless medium. Receiver 204 comprises an RF receiver to downconvert received RF signals to a baseband frequency. As discussed below, a BB processor at receiver 204 may further decode the signal to recover messages or frames transmitted by transmitter 202. In addition, a BB processor at receiver 204 may further detect a timing reference to be used in accurately determining a time of arrival messages or packets transmitted by transmitter 202. As pointed out above, controller/processor at receiver 204 may then apply determined times of arrival of messages or frames from transmitter 202 and/or other transmitters (not shown) in computing an estimated location of receiver 204.

To acquire a known bit sequence embedded within a payload of a probe signal, a receiver may capture time-synchronized chip rate in-phase and quadrature samples of the known bit sequence in order to estimate the frequency offset. A typical Zigbee receiver, however, may not allow access to in-phase and quadrature samples. A baseband processing part of a Zigbee receiver may be expected to capture in-phase and quadrature samples from an analog-to digital converter (ADC) at twice the chip rate (e.g., 4.0 Msps), detect the arrival of a probe signal packet by detecting the preamble, acquire the time and the frame synchronization and capture the appropriate in-phase and quadrature samples and finally estimate a frequency offset from the captured in-phase and quadrature samples.

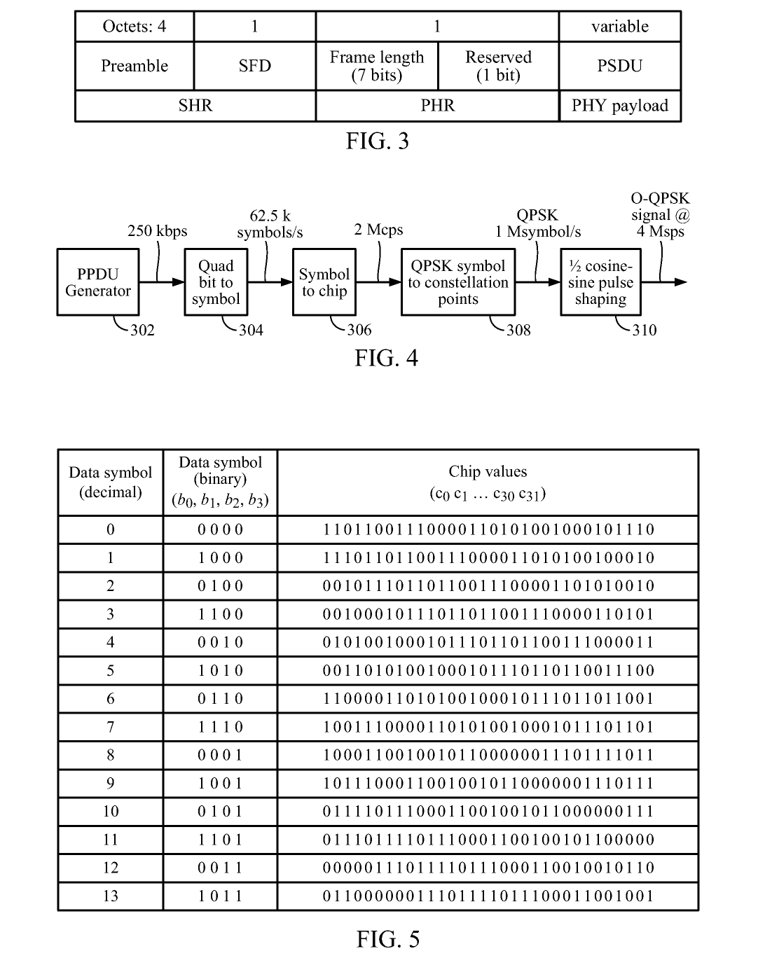

According to an embodiment, transmitter 202 may generate a PHY Protocol Data Unit (PPDU) packet as specified in the Zigbee specification. PPDU bits may then be grouped as quad-bits and mapped to symbols. FIG. 3, for example, shows fields of an example implementation of a PPDU according to IEEE std. 802.15.4 for Wireless Medium Access Control (MAC) and Physical Layer (PHY) Specifications for Low-Rate Wireless Personal Area Networks, May 12, 2003 (hereinafter “IEEE std. 802.15.4”). According to an embodiment, a receiver may process a known sequence of bits in a preamble field to obtain chip and symbol synchronization with an incoming message. A field PHR comprises a header. A field PDSU comprises a PHY payload receiver that may process a known bit sequence that may be used for further synchronization at a receiver.

FIG. 4 is a schematic diagram of an aspect of a transmitter (e.g. transmitter 202) for encoding a known bit sequence for transmission in a payload portion of a frame (e.g., PHY payload) according to an embodiment. In a particular implementation, a PPDU generator 302 may be implemented in a MAC layer device, for example, to generate a known bit sequence to be inserted into a the payload portion of the data frame. This may include, for example, a sequence of “0”s. However, other bit sequences may be used. Block 304 may provide a mapping of data symbols to a quad-bit representation as shown by example in the Table of FIG. 5. Block 306 may further map quad bit symbols to sequences of 32 chips as shown in the table of FIG. 5. Here, a 4-bit symbol may be mapped to a 32-bit orthogonal sequence resulting in chip rate of 2 Mcps. Block 308 may map sequences of chip values to offset quadrature phase shift keying (O-QPSK) constellation points. For example, block 308 may individually map 2-bit groups to O-QPSK signal constellation point as follows: 00 is mapped to −1−j, 01 to −1+j, 10 to 1−j and 11 to 1+j.

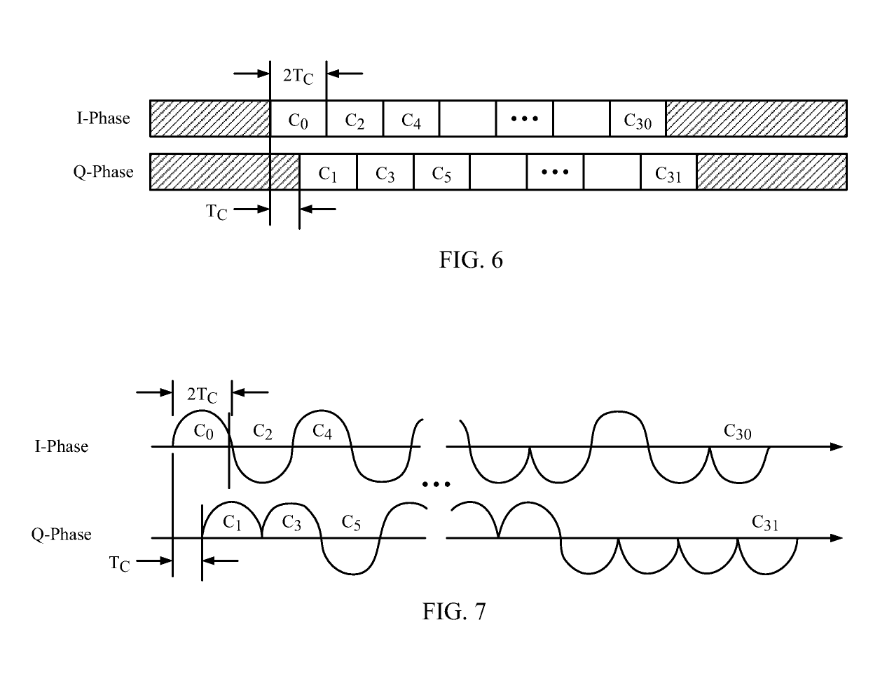

A particular example mapping of chip sequences of chip values to O-QPSK constellation points in illustrated in FIG. 6. Here, even-indexed chips are modulated onto an in-phase carrier and odd-indexed chips are modulated one a quadrature-phase carrier. To form an offset between chips modulated onto in-phase and quadrature carriers, quadrature-phase chips may be delayed by T_{C} where T_{C} is the inverse of the chip rate. Block 310 may apply pulse shaping to chips modulating the in-phase and quadrature carriers according to expression (1) as follows:

$$p ( t ) = \{ \begin{matrix}sin ( π \frac{t}{2 {T}_{c}} ) , & 0 \leq t \leq 2 {T}_{c} \\ 0 , & otherwise\end{matrix} \qquad ( 1 )$$

It may be shown that a O-QPSK pulse-shaped according to expression (1) may approach a minimum shift keying (MSK) signal.

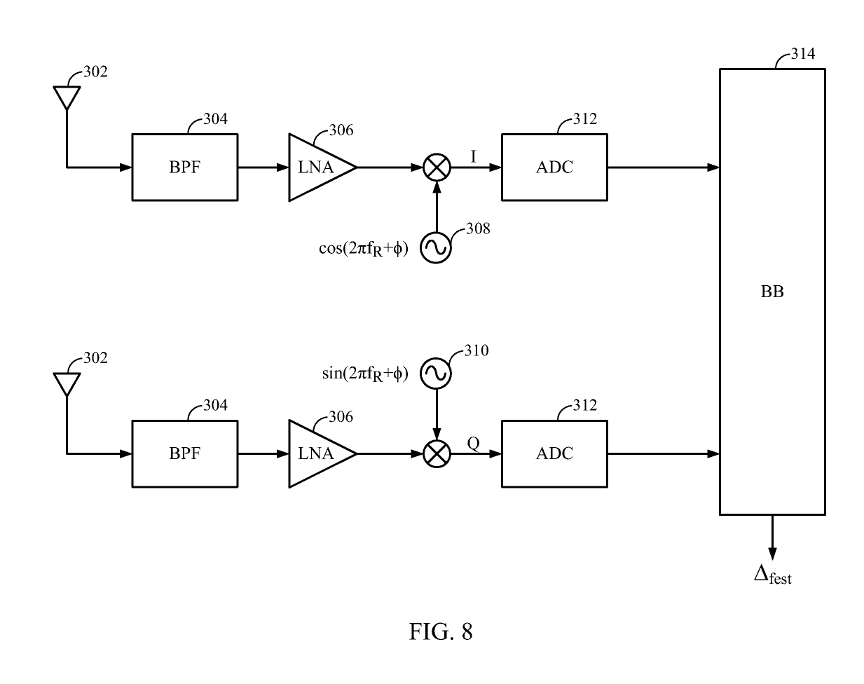

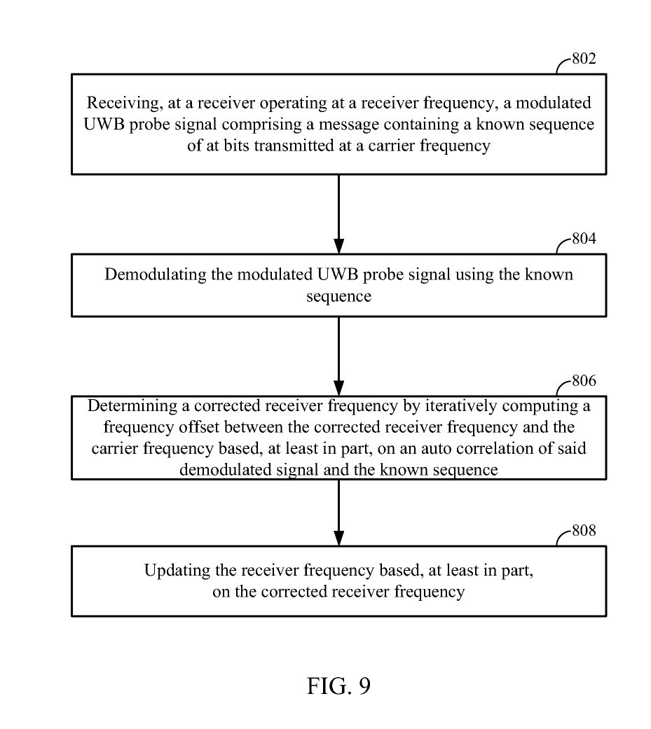

FIG. 8 is a schematic diagram of a receiver according to an embodiment of receiver 204. The receiver may comprise a heterodyne receiver capable of separating in-phase and quadrature components of a received signal (e.g., in-phase and quadrature components of a O-QPSK modulated message or frame). Antennas 302 may receive a wireless signal that is filtered at band pass filters 304 and amplified at low noise amplifiers 306. A portion of the received signal is then mixed with an oscillating signal cos(2πf_{R}+θ) generated from source 308 to isolate an in-phase component where f_{R} is a receiver frequency. Similarly, a portion of the received signal is then mixed with an oscillating signal sin(2πf_{R}+θ) generated from source 310 to isolate a quadrature component. The in-phase and quadrature components may then be processed by a BB processor 314 to, among other things, recover messages or frames transmitted in the received RF signal.

The RF signal received at antennae 302 may be transmitted at a particular carrier frequency f_{C}. In particular implementations, it may be desirable to closely match f_{R} with f_{C} to enable sufficiently accurate decoding of a predetermined sequence of bits and accurate measurement of times of arrival of the signal received (e.g., predetermined sequence of bits in a PHY payload field of a received PPDU). FIG. 9 is a flow diagram of a process to update receiver frequency f_{R} based, at least in part, on a corrected receiver frequency. First, at block 802, a receiver operating a receiver frequency f_{R} may receive a modulated wireless signal comprising a message containing a known sequence of at least 100 bits transmitted at a carrier frequency f_{C}. The message may comprise, for example, a PPDU including the known sequence of 100 bits in a PHY payload portion.

Block 804 may demodulate the modulated wireless signal using the known sequence. As pointed out above, a O-QPSK signal that has been pulse-shaped according to expression (1) may approach that of an MSK signal. As such, a baseband representation of such an MSK signal with a carrier offset may be expressed according to expression (2) as follows:

s(t)=Ae^{j[2πΔft+θ(t)]}+n(t) (2)

where:
Δf is an offset between a receiver frequency f_{R} and carrier frequency f_{C};
n(t) is noise;

$$θ ( t ) = θ ( 0 ) + \frac{π t}{2 {T}_{b}} if 1 was transmitted$$

$$θ ( t ) = θ ( 0 ) - \frac{π t}{2 {T}_{b}} if 0 was transmitted$$

An expression of s(t) may be re-written as follows:

s(t)=Ae^{j[2πΔf+θ(0)+θ′(t)]}+n(t)

where

$${θ}^{′} ( t ) = {θ}_{k} + {b}_{k} ( t ) \frac{π t}{2 {T}_{b}}$$

It may be observed that at t=kT_{b}, θ′(t) can take four different values: 0; +/−π/2; π; and e^{jθ′(t)}=+/−1 or +/−j. Accordingly, given the transmitted sequence bₖ, sequence e^{θ′(kTb)} is known and can be used to remove modulation from s(t). Removal of modulation from expression (1) may provide the following expression (3):

xₙ=Ae^{j[2πnΔf/f}^{_{C}}^{+θ]}+νₙn=1, 2, . . . N (3)

where:

f_{C}=1/T_{b} (which is the carrier frequency of the received signal);

vₙ is discrete time complex Gaussian noise with a variance of Nₒ;

θ is a carrier phase; and

N is a length of the known sequence of bits (e.g., provided in a PHY payload of a PPDU packet).

According to an embodiment, block 806 may determine a corrected receiver frequency f_{R} based, at least in part, on an autocorrelation of the demodulated signal obtained at block 804 and the known sequence. Such an autocorrelation may take the form of expression (4) as follows:

$${R}_{N} ( m ) = {\sum }_{k = m + 1}^{N} {x}_{k} {x}_{k - m}^{*} m = 1 , 2 , 3 , 4 , … J \qquad ( 4 )$$

where:

m is a parameter defining a depth of a correlator.

An estimated normalized frequency offset may then be given according to expression (5) as follows:

$$= \frac{{\sum }_{m ∈ \{ {m}_{1} , … , {m}_{J} \}} m * arg \{ {R}_{N} ( m ) \}}{2 π {\sum }_{m ∈ \{ {m}_{1} , … , {m}_{J} \}} {m}^{2}} \qquad ( 5 )$$

While expression (5) contemplates correlators of different depths m for computation of a normalized frequency offset, correlators of all depths from one to m_{J} are not necessarily used. For example, m=m₁, . . m_{J} may comprise less than the entire set of integers from one to m_{J}. As such, computation of a normalized frequency offset according to expression (5) may be adapted and/or optimized for performance and efficiency by varying different depths of correlators m (including non-consecutive integers mᵢ).

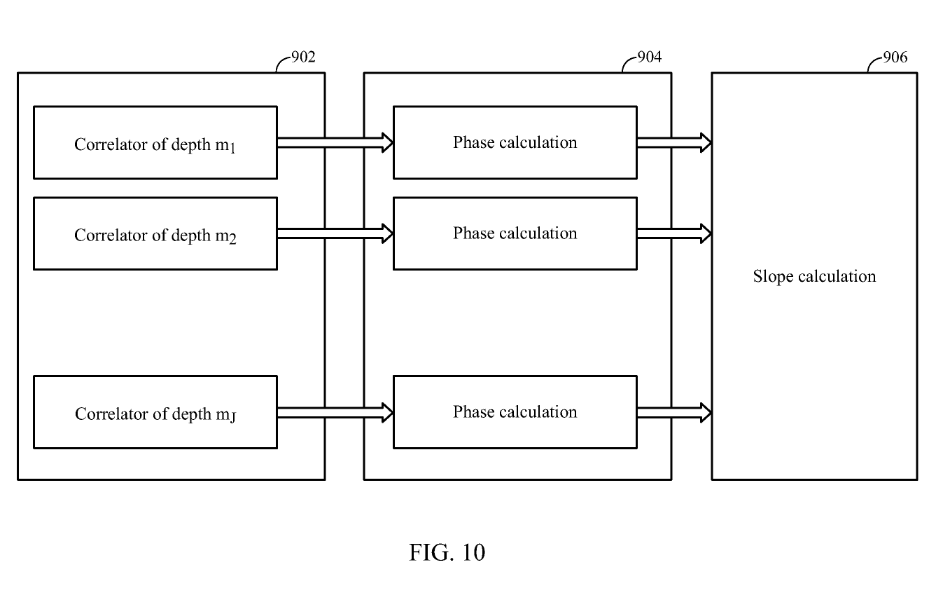

According to an embodiment, computation of an estimated normalized frequency offset may be implemented as shown in the schematic diagram of FIG. 10. In a particular implementation, features of FIG. 10 may be implemented in a baseband processor (e.g., baseband processor 314). According to an embodiment, computation according to expression (4) may be accomplished at section 902 which may be scaled for different values of m and J. In addition, computation according to expression (5) may be accomplished at sections 904 and 906 to provide a linear fit slope calculation as Δf.

Regarding expression (5), a maximum value of m_{J} may be constrained by a requirement that |m_{J}Δf/f_{C}|<<½. It may be observed that a large value for m_{J} may provide performance approaching a Cramer-Rao bound given in expression (6) as follows:

$${σ}_{Δ f}^{2} \geq \frac{6}{{( 2 π {T}_{c} )}^{2} N ( {N}^{2} - 1 ) SNR} \qquad ( 6 )$$

According to an embodiment, a particular Zigbee receiver may be designed to operate with up to a 40 parts per million frequency offset that corresponds to a maximum frequency error Δf=96.0 kHz, which may limit a maximum value of m_{J} to about 5. On the other hand, for a value of N=4096, an estimate performance may begin to approach the aforementioned Cramer-Rao bound at about m_{J}=600 or larger. Accordingly, as discussed below, a multi-stage approach to estimating Δf may be employed.

In a particular implementation, a frequency offset of a received probe signal (e.g., in a PPDU message) may be estimated in multiple stages. Initial stages may use a relatively small value of m_{J} to provide larger acquisition range but lower accuracy. Input samples may be corrected with an estimated frequency offset computed from a previous stage. In a particular implementation, three stages may be sufficient to reach estimator performance approaching the above referenced CR bound with 40 PPM initial frequency offset. In a first stage, m_{J}=5 may be used to obtain=1 KHz. This allows m_{J}<=50 in the second stage which results in of about 100 Hz after second stage so that m_{J}=600 can be used in a final stage.

In an implementation, an estimated frequency offset Δfₑₛₜ may be computed in multiple stages using an iterative process. In a particular example, Δfₑₛₜ may be computed in multiple stages summarized as follows:
1. Using samples xₙ and indices m=3 to 5, compute a first frequency offset Δf_{stage1} according to expressions (4) and (5);
2. Rotate samples xₙ by e^{-f[2πnΔf}^{_{stage1}}^{/f}^{_{C}}^{]}n=1, 2, 3, . . . 4096 to provide frequency corrected samples xₙ^{stage1};
3. Using frequency corrected samples xₙ^{stage1} and indices m=46 to 50, compute a second frequency offset Δf_{stage2} according to expressions (4) and (5);
4. Rotate samples xₙ^{stage1} by e^{-f[2πnΔf}^{_{stage2}}^{/f}^{_{C}}^{]}n=1, 2, 3, . . . 4096 to provide frequency corrected samples xₙ^{stage2}; and
5. Using frequency corrected samples xₙ^{stage2} and indices m=900 to 1000, compute the frequency offset Δf_{stage3}.

A final value for may be computed according to expression (7) as follows:

Δfₑₛₜ=Δf_{stage1}+Δf_{stage2}+Δf_{stage3}. (7)

In another particular implementation, in computing Δfₑₛₜ, components Δf_{stage}ⁱ may be weighted according to a filtering weight αᵢ according to expression (8) as follows:

Δfₑₛₜ=α₁Δf_{stage1}+α₂Δf_{stage2}+α₃Δf_{stage3}. (8)

In the example above, components of Δfₑₛₜ are computed in three iterative stages. In other implementations, Δfₑₛₜ may be computed using more or less than three iterative stages. Furthermore, it may be observed that a range of indices m used in computing components of Δfₑₛₜ (e.g., Δf_{stage1}, Δf_{stage2} and Δf_{stage3}). As pointed out above, using different ranges of m enables tailoring computing resources to compute associated components of Δfₑₛₜ with sufficient precision and without unnecessary use of the computational resources. In the above example, a range of m=3 to 5 is employed for computing Δf_{stage1} at a first stage, a range of m=46 to 50 is employed for computing Δf_{stage2} at a second stage and a range of m=900 to 1000 is employed for computing Δf_{stage3} at a third stage.

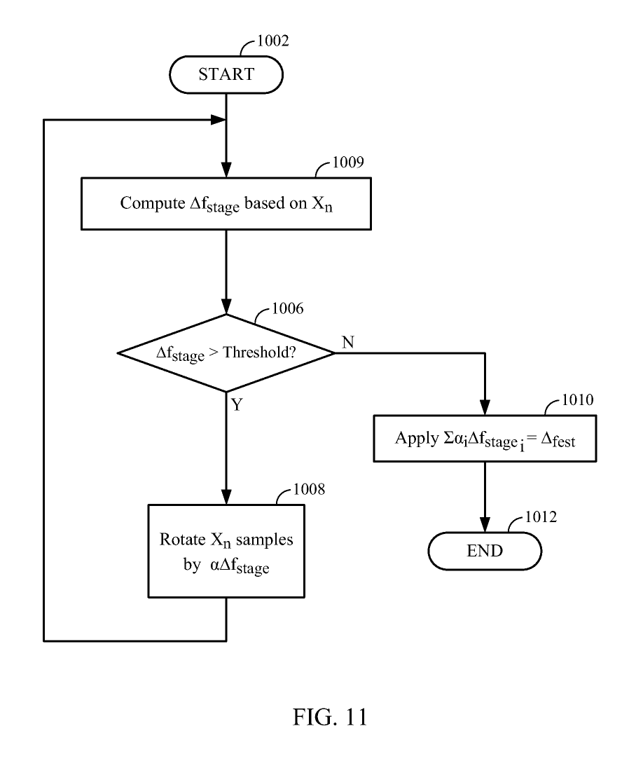

FIG. 11 is a flow diagram of a process for updating a receiver frequency f_{R} according to an embodiment. In response to a condition or event at start 1002, such as receipt of a PPDU message), the process may compute an initial portion of frequency offset Δf_{stage} based, at least in part, on frequency samples xₙ applying expressions (4) and (5) as discussed above. Diamond 1006 may compare a value of Δf_{stage} computed at block 1004 to a threshold. For example, if a computed value of Δf_{stage} obtained at block 1004 exceeds a threshold and does not approach performance of the aforementioned Cramer-Rao bound of expression (6), block 1008 may rotate samples xₙ by Δf_{stage} and block 1004 may recompute Δf_{stage} based on the rotated samples for xₙ. If a value of Δf_{stage} does not exceed a threshold at diamond 1006, block 1010 may compute a value for Δfₑₛₜ as a summation of Δf_{stage} obtained for iterations of block 1004.

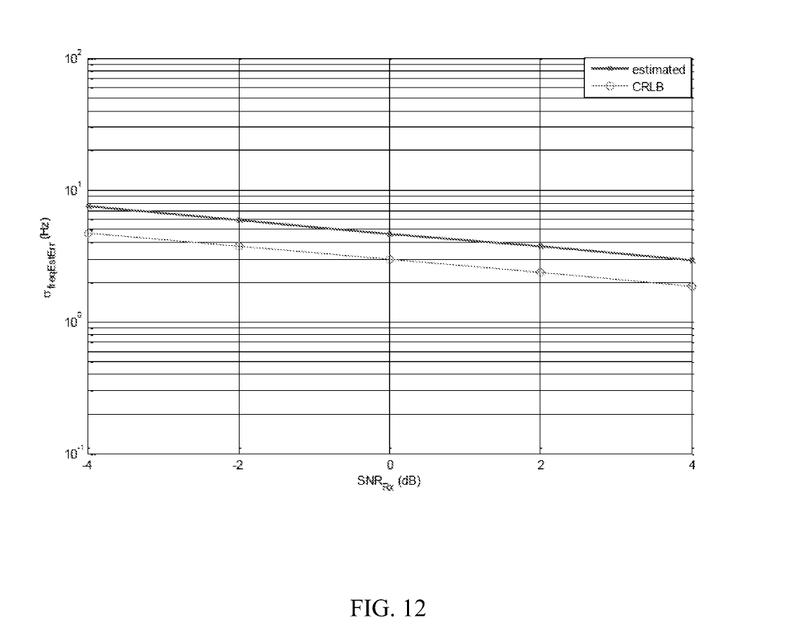

In particular implementations, any one of several values of a threshold may be applied at diamond 1006. For example, one threshold may be set at 40.0 ppm. Another threshold may be set at 10.0 Hz, 1.0 Hz, 0.1 Hz, or any other frequency value without deviating from claimed subject matter. Another threshold may be set at or approximately at three times a computed Cramer-Rao bound (e.g., according to expression (6)). In a particular implementation as shown in the plot of signal-to-noise ratio (SNR) and Cramer-Rao bound at FIG. 12, at any particular SNR value a threshold may be set as a function of the Cramer-Rao bound at that particular SNR value (e.g., three times the Cramer-Rao bound).

As pointed out above in connection with expression (8) in a particular implementation, values for an iteration of Δf_{stage} may weighted by a coefficient a at block 1008 for rotating samples of xₙ. Likewise, at block 1010 iterations of Δf_{stage}ⁱ may be weighted by coefficients αᵢ according to a filter model.

In particular implementations of block 1004, ranges for values of mε{m₁, . . . , j_{J}} applied to expressions (4) and (5) for computing iterations of Δf_{stage} may be varied as described in the particular example described above. For example, smaller ranges of m indices may be applied in earlier iterations for obtaining coarser components of Δfₑₛₜ while larger ranges of m indices may be applied in later iterations for obtaining finer components of Δfₑₛₜ.

As used herein, the term “mobile device” refers to a device that may from time to time have a position location that changes. The changes in position location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. 4G Long Term Evolution (LTE) communications networks may also be implemented in accordance with claimed subject matter, in an aspect. A WLAN may comprise an IEEE 802.11x network, and a WPAN may comprise a Bluetooth or Zigbee network, an IEEE 802.15x network, for example. Wireless communication implementations described herein may also be used in connection with any combination of WWAN, WLAN or WPAN.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method of determining a frequency offset between a carrier frequency and a receiver frequency on a device for coherent integration of an ultra-wideband (UWB) probe signal, comprising:
receiving, at a receiver operating at the receiver frequency, a UWB probe signal, comprising a message containing a known sequence of bits, said UWB probe signal comprising the carrier frequency;
demodulating the UWB probe signal using the known sequence of bits;
determining a corrected receiver frequency by iteratively computing the frequency offset, the frequency offset being between the corrected receiver frequency and the carrier frequency based on an autocorrelation of said demodulated UWB probe signal; and
updating the receiver frequency based, at least in part, on the corrected receiver frequency.

2. The method of claim 1, wherein determining the corrected receiver frequency further comprises determining a first frequency offset to include at least a first portion of an offset between the carrier frequency and the receiver frequency.

3. The method of claim 2, wherein determining the corrected receiver frequency further comprises determining a second frequency offset to include at least a second portion of the frequency offset between the carrier frequency and the corrected receiver frequency.

4. The method of claim 3, wherein updating the receiver frequency comprises rotating samples of said demodulated UWB probe signal by an amount based, at least in part, on a sum of said first frequency offset and said second frequency offset.

5. The method of claim 3, wherein determining the corrected receiver frequency further comprises determining a third frequency offset, based upon a frequency offset between the carrier frequency and the corrected receiver frequency.

6. The method of claim 5, wherein updating the receiver frequency comprises rotating samples of said demodulated UWB probe signal by an amount based, at least in part, on a sum of said first frequency offset, said second frequency offset and said third frequency offset.

7. The method of claim 1, wherein determining the corrected receiver frequency further comprises iteratively computing the frequency offset in incremental offsets until a computed incremental offset does not exceed a threshold.

8. The method of claim 1, wherein determining the corrected receiver frequency based, at least in part, on a combination of computed incremental offsets.

9. The method of claim 1, wherein the known sequence of bits comprises at least 100 bits.

10. A device for coherent integration of an ultra-wideband (UWB) probe signal comprising:
a radio frequency (RF) receiver to downconvert a UWB probe signal comprising a carrier frequency according to a receiver frequency, the UWB probe signal comprising a message containing a known sequence of bits; and
a baseband processor to:
demodulate the UWB probe signal using the known sequence of bits;
determine a corrected receiver frequency by iteratively computing a frequency offset between the corrected receiver frequency and the carrier frequency based on an autocorrelation of said demodulated UWB probe signal; and
update the receiver frequency based, at least in part, on the corrected receiver frequency.

11. The device of claim 10, wherein said baseband processor is to further determine the corrected receiver frequency further by determining a first frequency offset to include at least a first portion of an offset between the carrier frequency and the receiver frequency.

12. The device of claim 11, wherein said baseband processor is to further determine the corrected receiver frequency further by determining a second frequency offset to include at least a second portion of the frequency offset between the carrier frequency and the corrected receiver frequency.

13. The device of claim 12, wherein the baseband processor is to further update the receiver frequency by rotating samples of said demodulated UWB probe signal by an amount based, at least in part, on a sum of said first frequency offset and said second frequency offset.

14. The device of claim 12, wherein the baseband processor is to further determine the receiver frequency by determining a third frequency offset, based upon the offset between the carrier frequency and the corrected receiver frequency.

15. The device of claim 14, wherein the baseband processor is to further update the receiver frequency by rotating samples of said demodulated UWB probe signal by an amount based, at least in part, on a sum of said first frequency offset, said second frequency offset and said third frequency offset.

16. The device of claim 10, wherein the baseband processor is to further determine the corrected receiver frequency by iteratively computing the frequency offset in incremental offsets until a computed incremental offset does not exceed a threshold.

17. The device of claim 16, wherein the known sequence of bits comprises 100 bits.

18. A device for coherent integration of an ultra-wideband (UWB) probe signal comprising:
means for receiving, at a receiver operating at a receiver frequency, the UWB probe signal, comprising a message containing a known sequence of bits, said UWB probe signal comprising a carrier frequency;
means for demodulating the UWB probe signal using the known sequence of bits;
means for determining a corrected receiver frequency by iteratively computing a frequency offset between the corrected receiver frequency based on an autocorrelation of said demodulated UWB probe signal; and
means for updating the receiver frequency based, at least in part, on the corrected receiver frequency.

19. The device of claim 18, wherein said means for determining the corrected receiver frequency further comprises means for iteratively computing the frequency offset in incremental offsets until a computed incremental offset does not exceed a threshold.

20. The device of claim 18, wherein the known sequence of bits comprises at least 100 bits.
